(19) United States
(12) Patent Application Publication
(10) Pub. No.: US 2025/0085696 A1
(43) Pub. Date: Mar. 13, 2025

(54) ABNORMALITY DETECTION APPARATUS, METHOD, AND NON-TRANSITORY COMPUTER READABLE MEDIUM

(71) Applicant: KABUSHIKI KAISHA TOSHIBA, Tokyo (JP)

(72) Inventors: Wataru WATANABE, Tokyo (JP); Jumpei ANDO, Yokohama Kanagawa (JP); Toshiyuki ONO, Kawasaki Kanagawa (JP)

(73) Assignee: KABUSHIKI KAISHA TOSHIBA, Tokyo (JP)

(21) Appl. No.: 18/814,837

(22) Filed: Aug. 26, 2024

(30) Foreign Application Priority Data
Sep. 12, 2023 (JP) 2023-147843

(51) Int. Cl. G05B 19/418

(52) U.S. Cl. CPC G05B 19/4184

(57) ABSTRACT

According to one embodiment, an abnormality detection apparatus includes a processor. The processor acquires analysis data, the analysis data including at least operation data among the operation data and history data, the operation data being data of a manufacturing apparatus configured to intermittently process at least one product, the history data relating to a manufacturing history of the product processed by the manufacturing apparatus. The processor sets an operational state of the manufacturing apparatus in the operation data based on the acquired analysis data. The processor detects abnormality of the manufacturing apparatus based on the operation data and the set operational state.

### CROSS-REFERENCE TO RELATED APPLICATIONS

This application is based upon and claims the benefit of priority from Japanese Patent Application No. 2023-147843, filed Sep. 12, 2023, the entire contents of which are incorporated herein by reference.

### FIELD

Embodiments described herein relate generally to an abnormality detection apparatus, method, and non-transitory computer readable medium.

### BACKGROUND

In the manufacturing industry, abnormality of a manufacturing apparatus is detected based on the operation data of the manufacturing apparatus. In many cases, each time a manufacturing apparatus processes a product (e.g., makes, machines, assembles, and inspects a product), it makes preparations (e.g., carries out clean-up, adjustment, cleaning, maintenance) (i.e., intermittent processing) for processing the next product. A manufacturing apparatus sometimes temporarily stops the processing being performed to make preparations.

In particular, there is a need to detect abnormality of a manufacturing apparatus flexibly according to the “operational state” of the manufacturing apparatus. For example, one may wish to detect abnormality of the operation data in the state where the manufacturing apparatus is processing a product (i.e., a processing state) more strictly than the operation data in the state where the manufacturing apparatus is not processing a product (i.e., a non-processing state). However, operation data that does not include the operational state of the manufacturing apparatus cannot meet these wishes.

### BRIEF DESCRIPTION OF THE DRAWINGS

FIG. 1 is a block diagram showing an example of a function configuration of an abnormality detection apparatus according to a first embodiment.

FIG. 2 is a flowchart showing an example of an operation of the abnormality detection apparatus according to the first embodiment.

FIG. 3 is a diagram showing an example of operation data according to the first embodiment.

FIG. 4 is a diagram showing an example of history data according to the first embodiment.

FIG. 5 is a diagram showing a first example of an operational state according to the first embodiment.

FIG. 6 is a diagram showing a second example of an operational state according to the first embodiment.

FIG. 7 is a diagram showing an example of setting an operational state according to the first embodiment.

FIG. 8 is a diagram showing an example of abnormality detection for each operational state according to the first embodiment.

FIG. 9 is a diagram showing a first example of abnormality detection according to the first embodiment.

FIG. 10 is a diagram showing a second example of abnormality detection according to the first embodiment.

FIG. 11 is a diagram showing a third example of abnormality detection according to the first embodiment.

FIG. 12 is a diagram showing a fourth example of abnormality detection according to the first embodiment.

FIG. 13 is a block diagram showing an example of a function configuration of an abnormality detection apparatus according to a second embodiment.

FIG. 14 is a flowchart showing an example of an operation of the abnormality detection apparatus according to the second embodiment.

FIG. 15 is a block diagram showing an example of a function configuration of an abnormality detection apparatus according to a third embodiment.

FIG. 16 is a flowchart showing an example of an operation of the abnormality detection apparatus according to the third embodiment.

FIG. 17 is a block diagram showing an example of a hardware configuration of the abnormality detection apparatus according to each embodiment.

### DETAILED DESCRIPTION

In general, according to one embodiment, an abnormality detection apparatus includes a processor. The processor acquires analysis data, the analysis data including at least operation data among the operation data and history data, the operation data being data of a manufacturing apparatus configured to intermittently process at least one product, the history data relating to a manufacturing history of the product processed by the manufacturing apparatus. The processor sets an operational state of the manufacturing apparatus in the operation data based on the acquired analysis data. The processor detects abnormality of the manufacturing apparatus based on the operation data and the set operational state.

Hereinafter, each embodiment will be described with reference to the accompanying drawings. In the embodiments described below, elements assigned with the same reference symbols perform the same operations, and repeat descriptions will be omitted as appropriate.

### First Embodiment

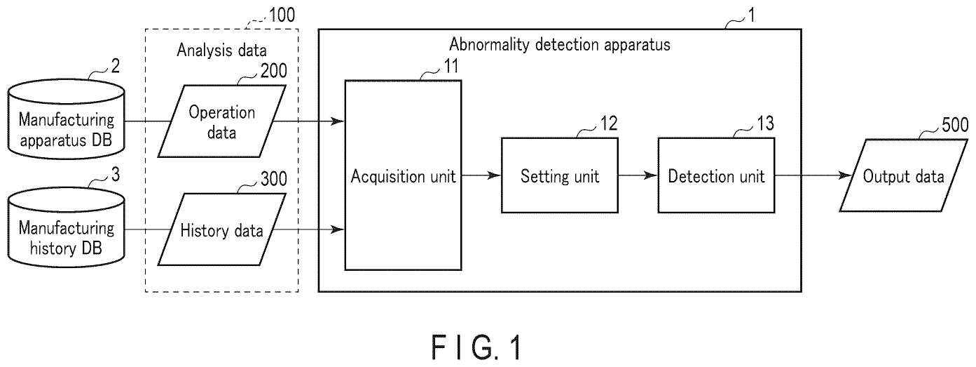

FIG. 1 is a block diagram showing an example of a function configuration of an abnormality detection apparatus 1 according to a first embodiment. The abnormality detection apparatus 1 is an apparatus that detects abnormality of a manufacturing apparatus M that intermittently processes at least one product (a material, an in-process item). The abnormality detection apparatus 1 is communicably connected to a manufacturing apparatus DB 2 and a manufacturing history DB 3. The abnormality detection apparatus 1 includes an acquisition unit 11, a setting unit 12, and a detection unit 13.

The acquisition unit 11 acquires various types of data. For example, the acquisition unit 11 acquires analysis data 100 that includes at least operation data 200 among the operation data 200 and history data 300. Specifically, the acquisition unit 11 acquires the operation data 200 from the manufacturing apparatus DB 2 and acquires the history data 300 from the manufacturing history DB 3. The acquisition unit 11 transfers the acquired analysis data 100 to the setting unit 12.

The operation data 200 is data obtained by measuring a numerical value (hereinafter also referred to as “a numerical operation value”) relating to the operation of the manufacturing apparatus M over time. The operation data 200 may be acquired over time by various sensors installed in the manufacturing apparatus M. The acquired operation data 200 is stored in the manufacturing apparatus DB 2.

The various sensors may be pre-installed or newly installed in the manufacturing apparatus M. The various sensors may or may not be connected to the manufacturing apparatus M. For example, a sensor such as a camera may measure the numerical operation value of the manufacturing apparatus M from a place distant from the manufacturing apparatus M.

The numerical operation value of the manufacturing apparatus M may be a numerical input value necessary for the operation of the manufacturing apparatus M, a numerical output value generated along with the operation of the manufacturing apparatus M, or a numerical value of the measurement of a product manufactured along with the operation of the manufacturing apparatus M. Firstly, the numerical operation value may be a temperature, pressure, current, voltage, etc., of the manufacturing apparatus M. Secondly, the numerical operation value may be data of a portion (module) of a product that is processed by the manufacturing apparatus M.

The numerical operation value may be a temperature of a portion of a product that is worked by the manufacturing apparatus M at a high or low temperature or a pressure of a portion of a product that is worked by the manufacturing apparatus M at a high or low pressure. The numerical operation value may be energy, a parameter, etc., for controlling the temperature, pressure, etc., of said portion. Thirdly, the numerical operation value may be data obtained by measuring the state of a product while the manufacturing apparatus M is working the product. The numerical operation value may be data obtained by measuring the transition or change in the temperature, color, shape, etc., of the product.

The operation data 200 is acquired and recorded constantly and over time, except in special circumstances. For example, since the manufacturing apparatus M intermittently processes a product, the sensor continues to measure the numerical operation value of the manufacturing apparatus M even during a time period in which the manufacturing apparatus M is not processing the product.

For example, if a camera measures the color of a product manufactured by the manufacturing apparatus M as the operation data 200, operation data 200 obtained by measuring the color of the background of the portion of the product that is supposed to be worked by the manufacturing apparatus M may be recorded during the time period in which the manufacturing apparatus M is not manufacturing the product.

The history data 300 is data relating to a manufacturing history of a product processed by the manufacturing apparatus M. The history data 300 may be automatically generated by the manufacturing apparatus M or manually generated. The generated history data 300 is stored in the manufacturing history DB 3.

The setting unit 12 sets various types of data. For example, the setting unit 12 sets an operational state of the manufacturing apparatus M in the operation data 200 based on the analysis data 100 acquired by the acquisition unit 11. The setting unit 12 transfers the operation data 200 in which an operational state is set to the detection unit 13.

The detection unit 13 detects various types of data. For example, the detection unit 13 detects abnormality of the manufacturing apparatus M based on the operation data 200 in which an operational state is set by the setting unit 12. The detection unit 13 outputs output data 500 that includes the result of the abnormality detection to an external device. The output data 500 may be a text file or an image file in a predetermined format (e.g., CSV, JSON, JPEG).

The manufacturing apparatus DB 2 is a database for storing the operation data 200 of the manufacturing apparatus M. The manufacturing history DB 3 is a database for storing the history data 300 of the manufacturing apparatus M. The manufacturing apparatus DB 2 and the manufacturing history DB 3 may be a text file in a predetermined format (e.g., CSV, JSON). The manufacturing apparatus DB 2 and the manufacturing history DB 3 may be integrated into a single database or text file.

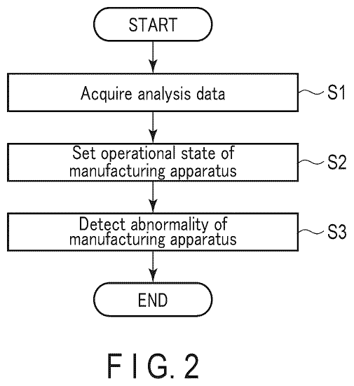

FIG. 2 is a flowchart showing an example of an operation of the abnormality detection apparatus 1 according to the first embodiment. The abnormality detection apparatus 1 may perform each step of the exemplary operation according to an instruction to start from a user. Alternatively, the abnormality detection apparatus 1 may perform each step of the exemplary operation at any time interval (e.g., daily, weekly, monthly).

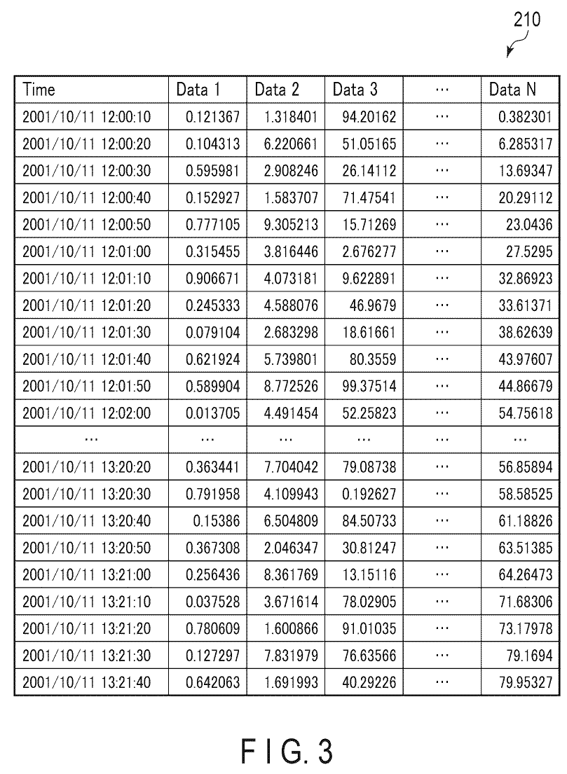

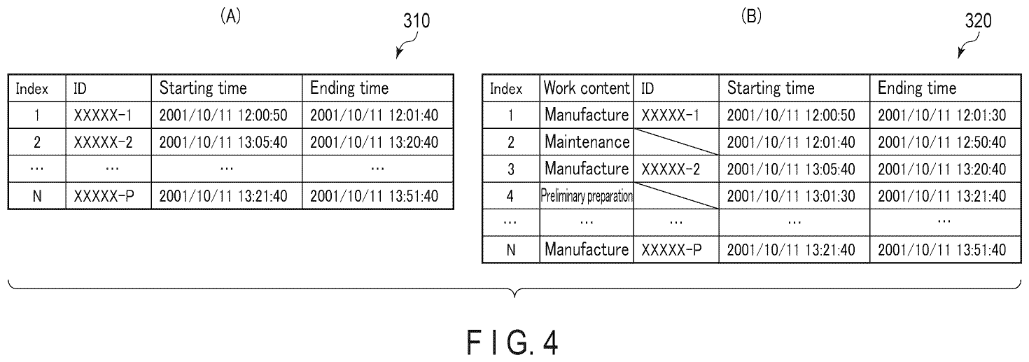

(Step S1) First, the acquisition unit 11 acquires the analysis data 100. The acquisition unit 11 may acquire, as the analysis data 100, an entirety or a portion of data only from the operation data 200 or from the operation data 200 and the history data 300. The acquisition unit 11 may acquire a predetermined scope of the analysis data 100 according to an analytical parameter input by a user or a separate system. The acquisition unit 11 may determine an analysis target scope of the operation data 200 (a data acquisition scope) by referring to the acquired operation data 200 or history data 300. The analysis target scope of the operation data 200 may be included in the analytical parameter (see FIGS. 3 and 4).

In particular, the acquisition unit 11 may add an amount of scope adjustment to the analytical parameter. According to the analytical parameter to which an amount of scope adjustment is added, the acquisition unit 11 may acquire a broader or narrower scope of the analysis data 100 than a predetermined scope based on the analytical parameter or acquire a scope of the analysis data 100 deviated from the predetermined scope. For example, the acquisition unit 11 acquires a broader scope of the analysis data 100 than a predetermined scope based on the analytical parameter. Thus, the acquisition unit 11 can prevent loss of the analysis data 100 needed for the analysis and prevent failure in the correspondence between the operation data 200 and the history data 300.

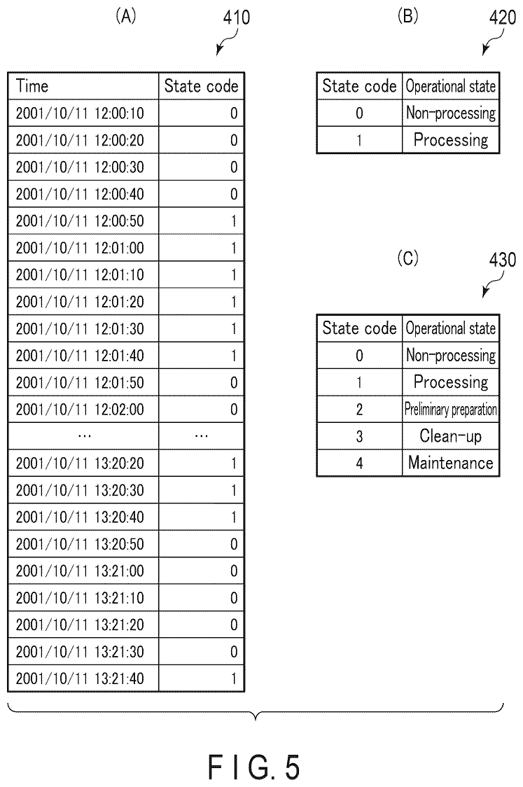

(Step S2) Next, the setting unit 12 sets an operational state of the manufacturing apparatus M. Specifically, the setting unit 12 sets an operational state of the manufacturing apparatus M in the operation data 200 based on the analysis data 100 acquired in step S1. The setting unit 12 may set an operational state of the manufacturing apparatus M in the entirety or a portion of operation data 200 (see FIGS. 5, 6, and 7).

In particular, the setting unit 12 may set a predetermined operational state in a period from the time when a value of the operation data 200 exceeds a threshold to the time when the value of the operation data 200 falls below the threshold. Alternatively, the setting unit 12 may set a predetermined operational state in a period from the time when a value of the operation data 200 falls below a threshold to the time when the value of the operation data 200 exceeds the threshold. Thus, the setting unit 12 can appropriately set an operational state in the operation data 200 according to the variation in the value of the operation data 200.

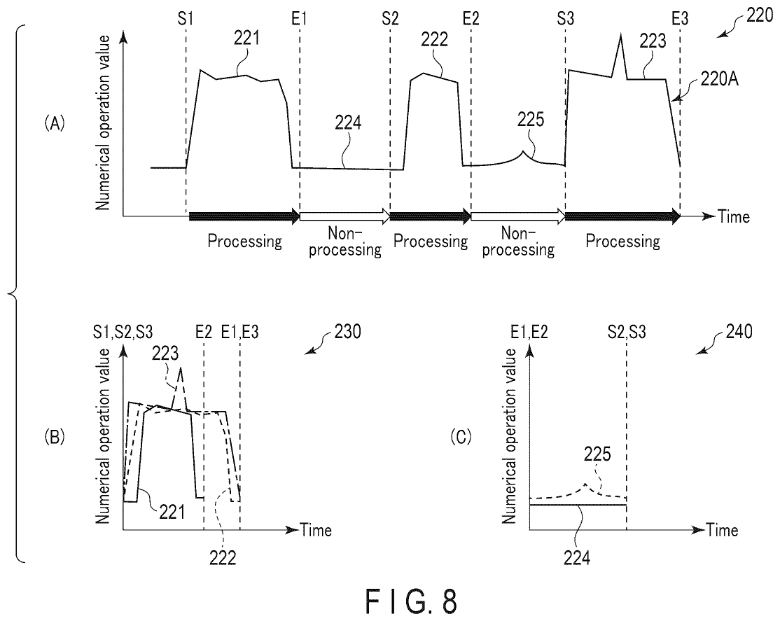

(Step S3) Lastly, the detection unit 13 detects abnormality of the manufacturing apparatus M. Specifically, the detection unit 13 detects the abnormality of the manufacturing apparatus M based on the operation data 200 that includes the operational state set in step S2. The detection unit 13 may detect the abnormality of the manufacturing apparatus M using a known statistical method or machine learning method. The detection unit 13 may perform a different abnormality detection method for each operational state of the manufacturing apparatus M according to an analytical parameter input by a user or a separate system. The detection unit 13 outputs the output data 500 that includes the result of the detection of the abnormality of the manufacturing apparatus M to an external device (see FIGS. 8, 9, 10, 11, and 12).

The detection unit 13 may compute a “degree of abnormality” of the operation data 200 as a result of the detection of the abnormality of the manufacturing apparatus M. The degree of abnormality indicates the level or certainty of abnormality. The degree of abnormality may be a continuous value or a discrete value. For example, “Degree of abnormality: 0” indicates “absence of abnormality”, and “Degree of abnormality: 1” indicates “presence of abnormality”. In this case, the closer the degree of abnormality to “1”, the higher the degree of abnormality of the operation data 200. Alternatively, the degree of abnormality may be a category value such as “presence of abnormality”, “caution”, “warning”, etc.

The detection unit 13 may compute the degree of abnormality according to the period in which or the frequency at which a value of the operation data 200 exceeds a threshold. The threshold may be a predetermined value or a value calculated from an average and a standard deviation of the values of the operation data 200 in a predetermined range (e.g., three times the standard deviation).

The detection unit 13 may compute the degree of abnormality as a probability value in a chi-square distribution from an average and a standard deviation of the values of the operation data 200 based on Hotelling's theory. The probability value being smaller indicates that the values of the operation data 200 are abnormal (a variation that rarely occurs). Alternatively, the detection unit 13 may compute a value of 0 to 1 as a probability value in a 1-chi-square distribution. The detection unit 13 may compute a probability value in a chi-square distribution under the definition that a smaller value indicates a higher degree of abnormality.

The detection unit 13 may subject the operation data 200 to pre-processing and compute the degree of abnormality based on the operation data 200 subjected to the pre-processing. Firstly, the detection unit 13 may perform denoising, a moving average, or an interval average as pre-processing. Thus, the detection unit 13 can alleviate the influence of the noise included in the operation data 200 or an unintended steep change on the computation of the degree of abnormality. Secondly, the detection unit 13 may perform a difference, a cumulative sum, a differential, or an integration as pre-processing. The pre-processing is effective when an amount of change in the value of the operation data 200, not an absolute value of the value of the operation data 200, relates to the abnormality. Thirdly, the detection unit 13 may perform four arithmetic operations of a specific data column of the operation data 200 as pre-processing. For example, an actual measured value of a pressure at which the manufacturing apparatus M works a product may be recorded as the operation data 200. The detection unit 13 divides the actual measured value by a value of the pressure set in the manufacturing apparatus M. Thus, the detection unit 13 converts the actual measured value into a value indicating the percentage of the set value of the pressure at which the product has been worked. Accordingly, the detection unit 13 can easily detect the abnormality of the manufacturing apparatus M through threshold processing.

The detection unit 13 may compute the degree of abnormality of a waveform of operation data 200 as a processing target (i.e., a target waveform) using a waveform of normal operation data 200 (i.e., a normal waveform). For example, the detection unit 13 computes a degree of discrepancy between the normal waveform and the target waveform as the degree of abnormality. The degree of discrepancy may be a simple difference or a RMSE (root mean squared error). Alternatively, the detection unit 13 associates two waveforms having different lengths with each other using DTW (dynamic time warping). If a difference between two waveforms exceeds a reference, the detection unit 13 may compute a high degree of abnormality.

The detection unit 13 may add a label to normal operation data 200 and abnormal operation data 200. The detection unit 13 may train a machine learning model (e.g., a perceptron, a support vector machine, a decision tree, a neural network) through supervised learning using the normal operation data 200 and the abnormal operation data 200 to which a label is added. The detection unit 13 may classify the operation data 200 as a processing target into a “normal” class or an “abnormal” class (abnormal mode) using the trained machine learning model.

The detection unit 13 may train a machine learning model so as to compute the degree of abnormality of normal operation data 200 as “0” and compute the degree of abnormality of abnormal operation data 200 as “1”. The detection unit 13 may compute the degree of abnormality of operation data 200 as a processing target so as to regress to “0” or “1” using the trained machine learning model. The detection unit 13 may adopt various regression approaches (e.g., single regression, multiple regression, kernel regression, support vector regression, neural network regression).

The detection unit 13 may compute a feature of normal operation data 200 using multiple types of normal operation data 200. The detection unit 13 may train a machine learning model through unsupervised learning using the computed feature. The detection unit 13 may compute a degree of discrepancy of operation data 200 as a processing target from normal operation data 200 as the degree of abnormality using the trained machine learning model.

Multiple types of normal operation data 200 may be data determined to be normal by a human. Alternatively, multiple types of normal operation data 200 may be data in a period in which the yield of the manufacturing apparatus M is relatively good or data in a period in which no trouble occurs in the manufacturing apparatus M.

In supervised learning or unsupervised learning, the detection unit 13 may train a machine learning model using not only the operation data 200 but also the operational state of the manufacturing apparatus M set in the operation data 200. Thus, the detection unit 13 can acquire an appropriate parameter for each operational state of the manufacturing apparatus M and train a machine learning model using the acquired parameter.

The detection unit 13 may detect the abnormality of the operation data 200 by analyzing the operation data 200 in a time series. The detection unit 13 may use various models (e.g., an autoregressive model, an autoregressive integrated moving average model, a hidden Markov model, an LSTM (long short term memory), Transformer).

FIG. 3 is a diagram showing an example of the operation data 200 according to the first embodiment. A table 210 shows operation data 200 corresponding to one manufacturing apparatus M. The table 210 includes items “time”, “data 1”, “data 2”, “data 3”, . . . “data N” in the row direction and includes each record relating to each item in the line direction.

The item “time” is the time at which each record is recorded. According to the table 210, each record is recorded at an interval of ten seconds. The recording interval may be any time interval or an irregular time interval. Instead of the “time”, the order of each processing performed by the manufacturing apparatus M or a serial number (e.g., 1, 2, 3, . . . ) indicating a time interval may be recorded.

The items “data 1” . . . “data N” are various types of operation data 200. According to the table 210, N types of data are recorded (N being any natural number). Each type of data may be a measurement value of temperature, pressure, current, or voltage measured by a sensor for a predetermined part of the manufacturing apparatus M. Each type of data may be a continuous value or a discrete value. If there are multiple manufacturing apparatuses

M, operation data 200 similar to the table 210 may be acquired for each of the manufacturing apparatuses M. The manufacturing apparatus DB 2 may store table data or file data corresponding to each piece of operation data 200 acquired. Alternatively, the table 210 may include a data column relating to an identifier (e.g., an apparatus number) identifying each of the manufacturing apparatuses M.

The acquisition unit 11 may determine an analysis target scope by referring to the operation data 200 (the table 210). As described above, the manufacturing apparatus M intermittently processes a product. A type of operation data 200 changes according to the intermittent processing performed by the manufacturing apparatus M. Firstly, if the operation data 200 shows a measurement value of pressure, the measurement value increases as the manufacturing apparatus M starts pressurization processing, and decreases as the pressurization processing ends. Secondly, if the operation data 200 shows a measurement value of current or voltage, the measurement value increases as the manufacturing apparatus M starts processing using power, and decreases as the processing using power ends. Pressure, power, current, voltage, etc., are examples of the operation data 200.

The acquisition unit 11 may determine, as the analysis target scope of the operation data 200, a period from the time at which the value of the operation data 200 reaches a value equal to or above a threshold to the time at which the value of the operation data 200 reaches a value equal to or below the threshold. If the value or the change in the value of the operation data 200 satisfies a predetermined condition, the acquisition unit 11 may determine a period satisfying the condition as the analysis target scope of the operation data 200. That is, the acquisition unit 11 may determine the analysis target scope according to the intermittent processing performed by the manufacturing apparatus M.

The acquisition unit 11 may correct the influence of the rounding of the value of the history data 300 by using the change in the value of the operation data 200 after determining the analysis target scope of the operation data 200 based on the history data 300. This method is effective in such a case as when the starting time and the ending time recorded in the history data 300 are rounded.

FIG. 4 is a diagram showing an example of the history data 300 according to the first embodiment. A table 310 in FIG. 4(A) shows the history data 300 according to an example. A table 320 in FIG. 4(B) shows the history data 300 according to another example. The tables 310 and 320 are the history data 300 corresponding to one manufacturing apparatus M. Each time the manufacturing apparatus M processes a product, a record is recorded in the tables 310 and 320.

The tables 310 and 320 include the items “Index”, “ID”, “starting time”, and “ending time” in the row direction and includes each record relating to each item in the line direction. In particular, the table 320 further includes an item “work content” in the row direction.

The item “Index” is a number (e.g., a processing order) uniquely identifying each processing intermittently performed by the manufacturing apparatus M. The item “ID” is a number (e.g., a component number, a lot number, a serial number, a batch number) of a product processed by the manufacturing apparatus M. The items “starting time” and “ending time” are a starting time and an ending time of the processing corresponding to the “Index” and “ID”. A period between the starting time and the ending time relating to the processing is a “processing time” of the processing.

The “starting time” and the “ending time” may be rounded to any grading (e.g., units of one minute, units of one hour). In particular, if the history data 300 is recorded manually, the acquisition unit 11 may round this history data 300 to any grading.

The item “work content” indicates specific content of the processing performed by the manufacturing apparatus M. The “work content” may be “manufacture”, “maintenance”, “preliminary preparation” or “clean-up”. In particular, the “maintenance”, “preliminary preparation”, and “clean-up” are also referred to as “non-processing” since they do not target a product with a specific ID. A period between the starting time and the ending time relating to non-processing is a “non-processing time” of the non-processing.

If there are multiple manufacturing apparatuses M, history data 300 similar to the table 310 or 320 may be acquired for each of the manufacturing apparatuses M. The manufacturing history DB 3 may store table data or file data corresponding to each piece of history data 300 acquired. Alternatively, the table 310 or 320 may include a data column relating to an identifier (e.g., an apparatus number) identifying each of the manufacturing apparatuses M.

If one manufacturing apparatus M manufactures multiple kinds of products, history data 300 similar to the table 310 or 320 may be acquired for each of the products. The manufacturing history DB 3 may store table data or file data corresponding to each piece of history data 300 acquired. Alternatively, the table 310 or 320 may include a data column relating to an identifier (e.g., a product number) identifying each of the products.

The acquisition unit 11 may determine an analysis target scope of the operation data 200 by referring to the history data 300 (the table 310 or 320). The acquisition unit 11 may determine an analysis target scope based on the “starting time” and the “ending time” corresponding to the “ID” of the table 310 or 320. If multiple IDs correspond to the analysis target scope, the acquisition unit 11 may select at least one of the multiple IDs. If there are multiple analysis target scopes, the detection unit 13 may detect the abnormality of the operation data 200 corresponding to the multiple analysis target scopes.

The acquisition unit 11 may designate at least one “ID” as an analysis target scope in the table 310 or 320 relating to the history data 300. For example, the acquisition unit 11 acquires the history data 300 corresponding to a predetermined ID of the table 310 or 320. The acquisition unit 11 uses the starting time and the ending time included in the acquired history data 300 and thereby acquires the operation data 200 corresponding to the starting time and the ending time. This method is effective in a case such as when the detection unit 13 wishes to output an abnormality detection result relating to the operation data 200 obtained when the manufacturing apparatus M processes a specific product.

FIG. 5 is a diagram showing a first example of an operational state according to the first embodiment. The table 410 in FIG. 5(A) shows a state code set for each time point (each time) of the operation data 200. The table 420 in FIG. 5(B) shows a correspondence between a state code and an operational state according to an example. The table 430 in FIG. 5(C) shows a correspondence between a state code and an operational state according to another example. The table 410 includes the items “time” and

“state code” in the row direction and includes each record relating to each item in the line direction. The item “time” of the table 410 corresponds to the item “time” of the table 210 relating to the operation data 200 of the manufacturing apparatus M (see FIG. 3). The item “state code” of the table 410 corresponds to the item “state code” of the tables 420 and 430.

According to the table 410, the manufacturing apparatus M switches between a “non-processing state” and a “processing state” with time. The “time” and “state code: 0” are recorded in some of the records of the table 410. That is, at this time, the operational state of the manufacturing apparatus M is a “non-processing state”. The “time” and “state code: 1” are recorded in other records of the table 410. That is, at this time, the operational state of the manufacturing apparatus M is a “processing state”.

The “state code” of the table 410 may be replaced by the “operational state” of the table 420. That is, the table 410 may include a name (state name) relating to an operational state of the manufacturing apparatus M. The “state code” of the table 410 may include more operational states than the two types of operational states (0: non-processing, 1: processing) shown in the table 420. Specifically, the “state code” of the table 410 may include the five types of operational states (0: non-processing, 1: processing, 2: preliminary preparation, 3: clean-up, 4: maintenance) shown in the table 430.

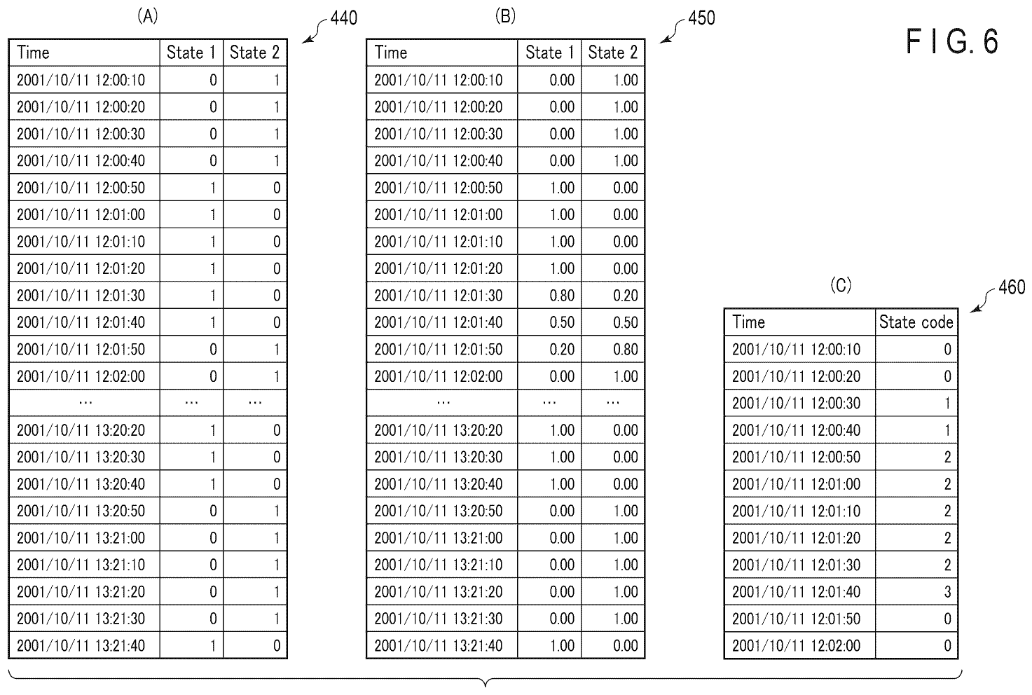

FIG. 6 is a diagram showing a second example of an operational state according to the first embodiment. The tables 440 and 450 shown in FIG. 6(A) and FIG. 6(B) include data columns respectively corresponding to two types of operational states, “state 1” and “state 2”. The table 460 shown in FIG. 6(C) includes one data column showing four types of operational states.

The tables 440 and 450 include the items “time”, “state 1”, and “state 2” in the row direction and include each record relating to each item in the line direction.

The item “time” of the tables 440 and 450 corresponds to the item “time” of the table 210 relating to the operation data 200 of the manufacturing apparatus M (see FIG. 3).

A numerical value “0” or “1” indicating the “state 1” or the “state 2” is recorded in each record of the table 440. The record in which the numerical value “0” is recorded means that the manufacturing apparatus M is not in the operational state at the time (i.e., not applicable). The record in which the numerical value “1” is recorded means that the manufacturing apparatus M is in the operational state at the time (i.e., is applicable).

Numerical values “0.00” to “1.00” indicating the “state 1” or the “state 2” are recorded in each record of the table 450. A numerical value closer to the numerical value “0.00” means a higher probability of the manufacturing apparatus M not being in the operational state at the time. A numerical value closer to the numerical value “1.00” means a higher probability of the manufacturing apparatus M being in the operational state at the time. That is, each numerical value from the numerical value “0.00” to the numerical value “1.00” indicates that the manufacturing apparatus M is in a state of shifting from one state to another state (i.e., a shifting state). Alternatively, each numerical value indicates that the operational state of the manufacturing apparatus M is uncertain.

The table 460 includes the items “time” and “state code” in the row direction and includes each record relating to each item in the line direction. The item “time” of the table 460 corresponds to the item “time” of the table 210 relating to the operation data 200 of the manufacturing apparatus M (see FIG. 3).

Each numerical value indicating the “state code” is recorded in each record of the table 460. According to one example, the numerical values indicate four types of operational states (0: non-processing, 1: preliminary preparation, 2: processing, 3: clean-up), respectively. According to another example, the numerical values indicate four types of operational states (0: non-processing, 1: rising, 2: processing, 3: falling), respectively. According to the table 460, the manufacturing apparatus M is switching among the four types of operational states one after another.

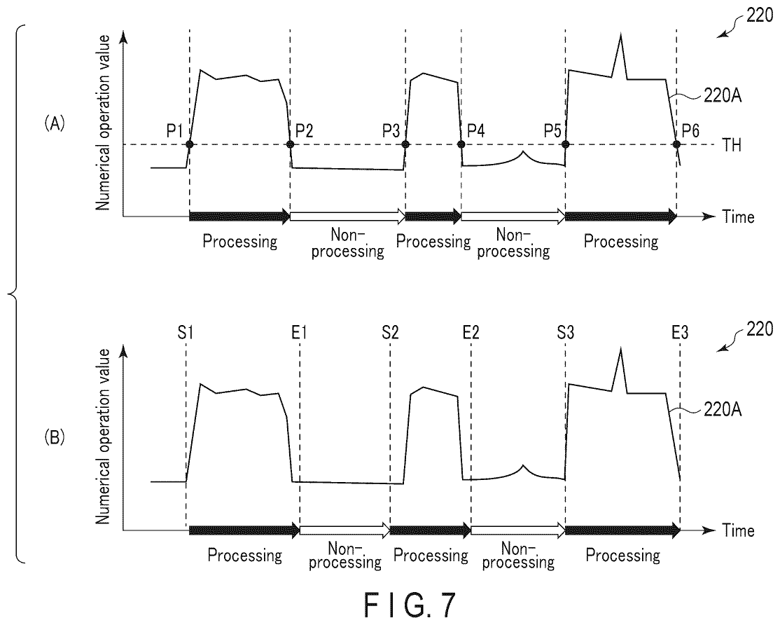

FIG. 7 is a diagram showing an example of setting an operational state according to the first embodiment. The graph 220 of FIG. 7(A) and FIG. 7(B) shows a change over time in time-series data 220A relating to the operation data 200. In the graph 220, the horizontal axis indicates “time” and the vertical axis indicates “numerical operation value” of the manufacturing apparatus M. The time-series data 220A may be any data among the “data 1” . . . “data N” of the table 210 (see FIG. 3).

As shown in FIG. 7 (A), the setting unit 12 may set a threshold TH for the time-series data 220A. For example, the setting unit 12 sets a “processing state” as an operational state of the manufacturing apparatus M for each time point at which the time-series data 220A is equal to or above the threshold TH. The setting unit 12 sets a “non-processing state” as an operational state of the manufacturing apparatus M for each time point at which the time-series data 220A is below the threshold TH.

Specifically, the setting unit 12 specifies intersection points P1, P2, P3, P4, P5, and P6 at which a value of the time-series data 220A reaches the threshold TH. The setting unit 12 specifies that a value of the time-series data 220A is equal to or above the threshold TH in each of the closed segments [P1, P2], [P3, P4], and [P5, P6]. The setting unit 12 sets a “processing state” as an operational state of the manufacturing apparatus M for each of the closed segments [P1, P2], [P3, P4], and [P5, P6].

On the other hand, the setting unit 12 specifies that a value of the time-series data 220A is below the threshold TH in each of the open segments (P2, P3) and (P4, P5). The setting unit 12 sets a “non-processing state” as an operational state of the manufacturing apparatus M for each of the open segments (P2, P3) and (P4, P5).

The setting unit 12 may set multiple thresholds in the time-series data 220A. For example, the setting unit 12 sets a first threshold and a second threshold larger than the first threshold in the time-series data 220A. Firstly, the setting unit 12 may set “rising” as an operational state of the manufacturing apparatus M in the segment from the point at which a value of the time-series data 220A exceeds the first threshold to the point at which the value of the time-series data 220A exceeds the second threshold. Secondly, the setting unit 12 may set “middle” as an operational state of the manufacturing apparatus M in the segment in which a value of the time-series data 220A exceeds the second threshold. Thirdly, the setting unit 12 may set “falling” as an operational state of the manufacturing apparatus M in the segment from the point at which a value of the time-series data 220A falls below the second threshold to the point at which the value of the time-series data 220A falls below the first threshold. That is, the setting unit 12 may set an operational state corresponding to a predetermined condition in the segment in which the time-series data 220A satisfies the predetermined condition.

As shown in FIG. 7 (B), the setting unit 12 may set an operational state of the manufacturing apparatus M for each time point of the time-series data 220A by associating the time-series data 220A with the history data 300. For example, the setting unit 12 refers to the “starting time” and the “ending time” of each processing in the table 310 or 320 relating to the history data 300 (see FIG. 4). The setting unit 12 sets a “processing state” as an operational state of the manufacturing apparatus M for each time point of the time-series data 220A between the “starting time” and the “ending time” of each processing. The setting unit 12 sets a “non-processing state” as an operational state of the manufacturing apparatus M for each time point of the time-series data 220A that is not between the “starting time” and the “ending time” of each processing.

Specifically, the setting unit 12 specifies, from the table 310 or 320, a starting time S1 and an ending time E1 of first processing, a starting time S2 and an ending time E2 of second processing, and a starting time S3 and an ending time E3 of third processing. The setting unit 12 sets a “processing state” as an operational state of the manufacturing apparatus M in each of the closed segments [S1, E1], [S2, E2], and [S3, E3] between the starting time and the ending time relating to each processing. On the other hand, the setting unit 12 sets a “non-processing state” as an operational state of the manufacturing apparatus M in each of the open segments (E1, S2) and (E2, S3).

The setting unit 12 may set a predetermined state according to the “work content” of the table 320 for each time point of the time-series data 220A between the “starting time” and the “ending time” of each processing (see FIG. 4). For example, the setting unit 12 divides the closed segment [S1, E1] into multiple sub-segments and sets an operational state (e.g., rising, middle, falling) of the manufacturing apparatus M in each sub-segment. The setting unit 12 may set each operational state by setting multiple thresholds in the time-series data 220A.

If the time-series data 220A satisfies a predetermined condition, the setting unit 12 may set an operational state corresponding the predetermined condition. Firstly, the setting unit 12 may set “preliminary preparation” for the period of five minutes immediately preceding the starting time of each processing. Secondly, the setting unit 12 may set “clean-up” for the period of ten minutes immediately preceding the ending time of each processing. Thirdly, the setting unit 12 may set “maintenance” for the period of one or more hours of non-processing time.

FIG. 8 is a diagram showing an example of abnormality detection for each operational state according to the first embodiment. The graph 220 of FIG. 8(A) shows the operational state (i.e., the processing state, the non-processing state) of the manufacturing apparatus M set in the time-series data 220A. The graph 220 of FIG. 8(A) is the same as the graph 220 of FIG. 7(B). The graph 230 of FIG. 8(B) shows time-series data 221, 222, and 223 in the “processing state”, taken from the time-series data 220A. The graph 240 of FIG. 8(C) shows time-series data 224 and 225 in the “non-processing state”, taken from the time-series data 220A.

The detection unit 13 specifies, in the time-series data 220A, each time-series data in the “processing state” of the manufacturing apparatus M. Specifically, the detection unit 13 specifies the time-series data 221 in the closed segment [S1, E1], the time-series data 222 in the closed segment [S2, E2], and the time-series data 223 in the closed segment [S3, E3]. The detection unit 13 takes out the specified time-series data 221, 222, and 223 from the time-series data 220A and superimposes them onto the graph 230.

In the graph 230, the starting points (i.e., the starting times) of the time-series data 221, 222, and 223 are set to the same time. Thus, a difference between the ending points (i.e., the ending times) of the time-series data 221, 222, and 223 is shown. A difference between the changes over time in the “numerical operation values” of the time-series data 221, 222, and 223 is also shown.

The detection unit 13 can selectively detect the abnormality of the manufacturing apparatus M in the “processing state” based on the graph 230. For example, the detection unit 13 can detect in which time-series data abnormality has occurred by comparing the time-series data 221, 222, and 223 with each other. Specifically, the detection unit 13 can detect the occurrence of an abnormality in the time-series data 223 having a peak value. That is, since the detection unit 13 selectively detects the abnormality of the manufacturing apparatus M that is in the middle of processing a product, it can contribute to the quality control of the product and alleviate the influence on the post-process performed after the product is processed.

Furthermore, the detection unit 13 can selectively detect the abnormality of the manufacturing apparatus M in each operational state (e.g., rising, middle, falling), which is a subdivision of the “processing state”. Thus, the detection unit 13 can improve the manufacturing process of a product performed by the manufacturing apparatus M.

On the other hand, the detection unit 13 specifies, in the time-series data 220A, each time-series data in the “non-processing state” of the manufacturing apparatus M. Specifically, the detection unit 13 specifies the time-series data 224 in the open segment (E1, S2) and the time-series data 225 in the open segment (E2, S3). The detection unit 13 takes out the specified time-series data 224 and 225 from the time-series data 220A and superimposes them onto the graph 240.

In the graph 240, the starting points (i.e., the starting times) of the time-series data 224 and 225 are set to the same time. Thus, a difference between the ending points (i.e., the ending times) of the time-series data 224 and 225 is shown. A difference between the changes over time in the “numerical operation values” of the time-series data 224 and 225 is also shown.

The detection unit 13 can selectively detect the abnormality of the manufacturing apparatus M in the “non-processing state” based on the graph 240. For example, the detection unit 13 can detect in which time-series data abnormality has occurred by comparing the time-series data 224 and 225 with each other. Specifically, the detection unit 13 can detect the occurrence of an abnormality in the time-series data 225 having a peak value. The abnormality of the manufacturing apparatus M in the non-processing state may relate to, for example, the deterioration of the manufacturing apparatus M. Since the detection unit 13 selectively detects the abnormality of the manufacturing apparatus M that is not in the middle of processing a product, it can detect the deterioration of the manufacturing apparatus M and contribute to the condition-based maintenance (CBM) of the manufacturing apparatus M.

Furthermore, the detection unit 13 can selectively detect the abnormality of the manufacturing apparatus M in each operational state (e.g., maintenance, clean-up), which is a subdivision of the “non-processing state”. Thus, the detection unit 13 can contribute to appropriate management of the manufacturing apparatus M.

Needless to say, the detection unit 13 may change the method of detecting the abnormality of the manufacturing apparatus M according to the operational state of the manufacturing apparatus M. For example, the detection unit 13 sets a threshold in the time-series data 221, 222, and 223 in the “processing state” of the manufacturing apparatus M so as not to permit even a fluctuation in a relatively small value. On the other hand, the detection unit 13 sets a threshold in the time-series data 224 and 225 in the “non-processing state” of the manufacturing apparatus M so as to permit a fluctuation in a relatively small value. In this manner, the detection unit 13 may change the criterion for setting a threshold for the abnormality detection according to the operational state of the manufacturing apparatus M. Therefore, the detection unit 13 can flexibly detect the abnormality of the manufacturing apparatus M.

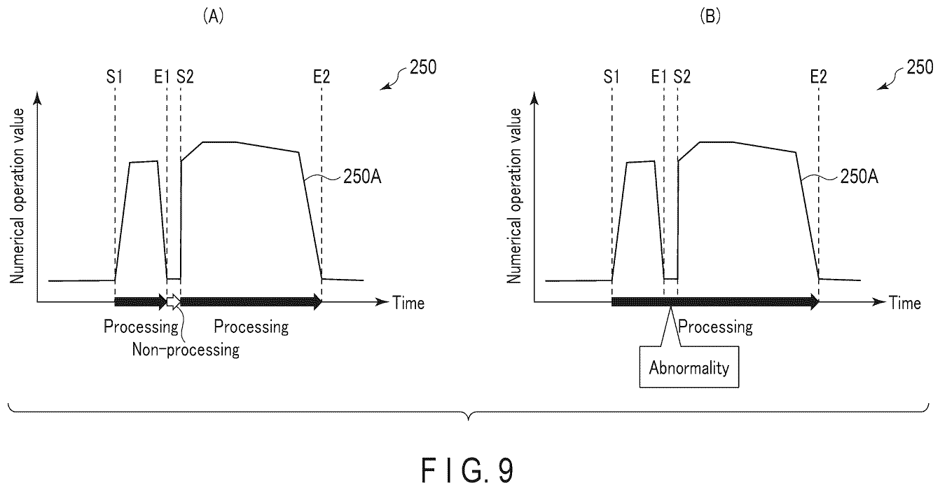

FIG. 9 is a diagram showing a first example of abnormality detection according to the first embodiment. The graph 250 of FIG. 9(A) and FIG. 9(B) shows a change over time in time-series data 250A relating to the operation data 200. This example assumes a case where the manufacturing apparatus M resumes the processing that the manufacturing apparatus M was performing but temporarily stopped due to emergency shutdown. In this case, the operation data 200 of the manufacturing apparatus M shifts in a sawtooth manner in the order of a peak, valley, and peak, as shown in the time-series data 250A.

As shown in FIG. 9 (A), the setting unit 12 sets a “processing state” in each of the closed segments [S1, E1] and [S2, E2] of the time-series data 250A. On the other hand, the setting unit 12 sets a “non-processing state” in the open segment (E1, S2) of the time-series data 250A. That is, the setting unit 12 sets each operational state in the time-series data 250A in the order of “processing state, non-processing state, and processing state”.

At this time, there is a fluctuation occurring in the period of “non-processing state” (E1, S2), such as a temporary decrease in the value of the time-series data 250A. Since this fluctuation is due to the emergency shutdown of the manufacturing apparatus M, one may wish to distinguish this fluctuation from a fluctuation occurring in the “processing state”. Alternatively, one may wish to detect this fluctuation as an abnormality and indicate to a surveillant that it is a fluctuation occurring in the “non-processing state”.

Thus, if the operational state of the manufacturing apparatus M changes in the order of “processing state, non-processing state, and processing state”, and the detection unit 13 performs abnormality detection in the period of “non-processing state”, the detection unit 13 adjusts the degree of abnormality in this period. For example, since a fluctuation caused by emergency shutdown is under control, if the detection unit 13 lowers the priority of monitoring this fluctuation, the detection unit 13 adjusts the degree of abnormality to be low. Alternatively, in the case of raising the priority of monitoring a fluctuation caused by emergency shutdown, the detection unit 13 adjusts the degree of abnormality to be high. Needless to say, the detection unit 13 may output information indicating the occurrence of an abnormality in the non-processing state together with an unadjusted normal degree of abnormality.

The detection unit 13 may adjust the degree of abnormality by adding a predetermined value to a normal degree of abnormality or multiplying a normal degree of abnormality by a predetermined value. Alternatively, the detection unit 13 may adjust the degree of abnormality by changing the abnormality detection method or a parameter such as a threshold.

As shown in FIG. 9 (B), a case is assumed in which the setting unit 12 sets a “processing state” in the closed segment [S1, E2] of the time-series data 250A. In this case, a “processing state” is also set in the open segment (E1, S2) included in the closed segment [S1, E2]. The detection unit 13 applies an abnormality detection method in the “processing state” rather than an abnormality detection method in the “non-processing state” to the open segment (E1, S2), whereby an abnormality is detected in the open segment (E1, S2).

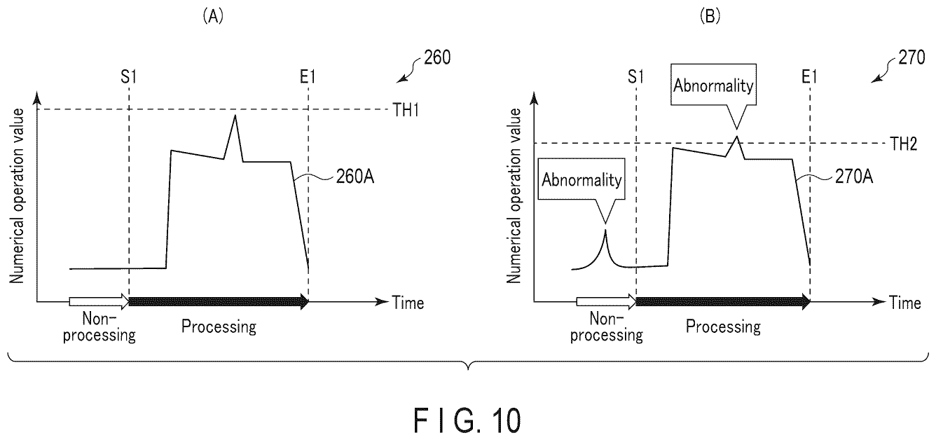

FIG. 10 is a diagram showing a second example of abnormality detection according to the first embodiment. The graph 260 of FIG. 10(A) shows a change over time in time-series data 260A relating to the operation data 200. The graph 270 of FIG. 10(B) shows a change over time in time-series data 270A different from the time-series data 260A.

The setting unit 12 sets a “non-processing state” in the period up to the starting time S1 of the time-series data 260A and 270A, and sets a “processing state” in another period [S1, E1] following said period. That is, the setting unit 12 sets each operational state in the time-series data 260A and 270A in the order of “non-processing state and processing state”.

At this time, if a fluctuation of the time-series data 260A or 270A occurs in the period of “non-processing state”, said fluctuation may affect a fluctuation of the time-series data 260A or 270A in the subsequent period of “processing state”.

Thus, the detection unit 13 may change the method or criterion for detecting abnormality based on the size of fluctuation (the amount of fluctuation) in the “processing state” in accordance with the size of fluctuation (the amount of fluctuation) in the “non-processing state”. For example, as the amount of fluctuation in the “non-processing state” becomes larger, the detection unit 13 sets a threshold for the amount of fluctuation in the “processing state” more strictly. That is, the detection unit 13 increases the detection sensitivity to the abnormality of the manufacturing apparatus M in the “processing state” more than the detection sensitivity to the abnormality of the manufacturing apparatus M in the “non-processing state”.

As shown in FIG. 10(A), the detection unit 13 sets a first threshold TH1 in the graph 260, and detects the abnormality of the time-series data 260A in the “processing state”. Since the first threshold THI is set to exceed a peak value of the time-series data 260A, the detection unit 13 does not detect the abnormality of the time-series data 260A.

As shown in FIG. 10(B), the detection unit 13 sets a second threshold TH2 in the graph 270, and detects the abnormality of the time-series data 270A in the “processing state”. Herein, abnormality is detected in the “non-processing state” prior to the “processing state”. Thus, the detection unit 13 sets the second threshold TH2 smaller than the first threshold THI so as to strictly detect the abnormality in the “processing state”. Since the second threshold TH2 is set to fall below a peak value of the time-series data 270A, the detection unit 13 detects the abnormality of the time-series data 270A. In this manner, the detection unit 13 can strictly detect the abnormality of the manufacturing apparatus M in the “processing state”.

In contrast, if abnormality occurs in the “non-processing state” after the “processing state”, it is assumed that the manufacturing apparatus M has deteriorated due to the processing performed by the manufacturing apparatus M in the “processing state” unlike in the normal non-processing state (such as maintenance, etc.). Thus, the detection unit 13 may change the abnormality detection method in the “non-processing state” if the operational state of the manufacturing apparatus M changes in the order of “processing state and non-processing state”.

For example, the detection unit 13 uses a method of detecting a shift (e.g., a monotonic increase and a monotonic decrease) in the operation data 200 in a longer period than usual as the abnormality detection method in the “non-processing state”. Alternatively, if the tendency given to the operation data 200 by the deterioration of the manufacturing apparatus M is known, the detection unit 13 may use a method of detecting this tendency. In this manner, the detection unit 13 can detect the deterioration of the manufacturing apparatus M in the “non-processing state”.

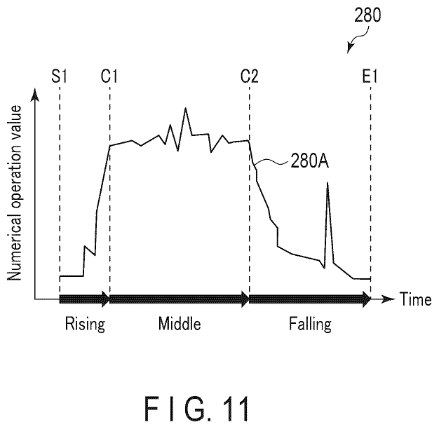

FIG. 11 is a diagram showing a third example of abnormality detection according to the first embodiment. The graph 280 of FIG. 11 shows a change over time in time-series data 280A relating to the operation data 200.

The setting unit 12 sets a “processing state” for the closed segment [S1, E1] of the time-series data 280A. The setting unit 12 divides the closed segment [S1, E1] into three sub-segments and sets each operational state for each of the sub-segments. Specifically, the setting unit 12 sets a “rising state” in the closed segment [S1, C1], sets a “middle state” in the closed segment [C1, C2], and sets a “falling state” in the closed segment [C2, E1].

The detection unit 13 may change the abnormality detection method according to each operational state. For example, the detection unit 13 detects the abnormality of the time-series data 280A in the “middle state” more strictly than the abnormality of the time-series data 280A in the “rising state” or “falling state”. Alternatively, the detection unit 13 may add a large weight to the degree of abnormality computed from the “middle state” and add a small weight to the degree of abnormality computed from the “rising state” or “falling state”. The detection unit 13 may compute, as the overall degree of abnormality of the time-series data 280A, the sum of the respective degrees of abnormality weighted for the respective operational states.

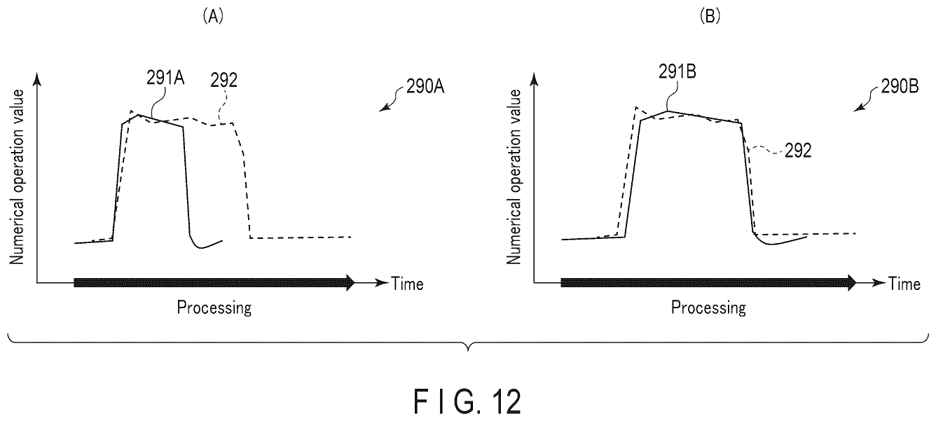

FIG. 12 is a diagram showing a fourth example of abnormality detection according to the first embodiment. The graph 290A of FIG. 12(A) shows a change over time in time-series data 291A and 292 relating to the operation data 200. The graph 290B of FIG. 12(B) shows a change over time in time-series data 291B and 292 relating to the operation data 200. Each of the time-series data 291A, 291B, and 292 is time-series data in the “processing state”.

In general, the processing time needed for the manufacturing apparatus M to process a product varies according to the amount of processing needed to process the product. The amount of processing corresponds to the physical amounts (e.g., a weight, a length, an area, a volume, a concentration) of a product to be processed. The amount of processing may be included in the history data 300 (see FIG. 4).

Hereinafter, explanations will be given using an example in which the amount of processing is a length. Simply stated, if the manufacturing apparatus M processes a product that is twice as long as usual, it requires twice the processing time as a normal processing time.

In the graph 290A, the time-series data 291A is waveform data of the case where the manufacturing apparatus M processes a product having a length of L [m]. The time-series data 292 is waveform data of the case where the manufacturing apparatus M processes another product having a length of 2L [m].

The setting unit 12 may convert the time-series data 291A and 292 based on the product processing amount, and the detection unit 13 may detect the abnormality of the manufacturing apparatus M based on the converted time-series data 291A and 292. Specifically, the setting unit 12 may normalize the length of the waveform of the time-series data 291A and the length of the waveform of the time-series data 292 using the product processing amount (L [m]) relating to the time-series data 291A and the product processing amount (2L [m]) relating to the time-series data 292. The detection unit 13 may detect the abnormality of the time-series data 291A and 292 by comparing the normalized lengths of the two waveforms with each other.

That is, the setting unit 12 may normalize the operation data 200 using the product processing amount. The detection unit 13 may compare two types of operation data 200 with each other and thereby detect the abnormality of the two types of operation data 200.

For example, if the time-series data 292 is reference data, the setting unit 12 extends the length of the waveform of the time-series data 291A twice in the time direction (horizontal axis direction). The extended time-series data 291A corresponds to the time-series data 291B of the graph 290B.

In the graph 290B, the detection unit 13 detects the abnormality of each of the time-series data 291B and 292 by comparing the time-series data 291B and 292 with each other. The time-series data 291B is regarded as waveform data of the case where the manufacturing apparatus M processes a product having a length of 2L [m]. That is, assuming that the manufacturing apparatus M processes two products having the same length (2L [m]), the detection unit 13 compares the time-series data 291B and 292 relating to the two products with each other.

As a result of the comparison, the detection unit 13 does not detect the abnormality of the time-series data 291B and 292. That is, the detection unit 13 determines that the difference between the time-series data 291A and 292 in the waveform length is attributed to the difference in the product processing amount. Thus, the detection unit 13 does not detect the abnormality of the time-series data 291A and 292.

In this manner, by normalizing the length of the waveform of the time-series data according to the product processing amount, the detection unit 13 can detect, with high precision, the abnormality of the operation data 200 of the case where the processing time varies according to the processing amount. Thus, the detection unit 13 can detect, as an abnormality, the case where the processing time is longer or shorter than a reference time because of the delay in the work, forgetting to perform the work, etc.

The processing described above can be rephrased as follows. The history data 300 includes the amount of the processing performed on a product. The setting unit 12 sets the processing state as the operational state of the manufacturing apparatus M in a predetermined period of the operation data 200. The detection unit 13 detects the abnormality of the manufacturing apparatus M based on the comparison between the processing amount in the processing state and the length of the predetermined period. In particular, the detection unit 13 normalizes the length of the predetermined period based on the processing amount and detects the abnormality of the manufacturing apparatus M based on the comparison between the processing amount and the normalized length of the predetermined period.

According to the first embodiment described above, the abnormality detection apparatus 1 can flexibly detect the abnormality of the manufacturing apparatus M according to the operational state of the manufacturing apparatus M. For example, the abnormality detection apparatus 1 can detect the abnormality of the operation data 200 in the state where the manufacturing apparatus M is processing a product (i.e., the processing state) more strictly than the operation data 200 in the state where the manufacturing apparatus M is not processing a product (i.e., the non-processing state).

In particular, the abnormality detection apparatus 1 can selectively detect the abnormality of the operation data 200 of the manufacturing apparatus M in a desired operational state. The abnormality detection apparatus 1 can enhance the performance of the detection of the abnormality of the manufacturing apparatus M by controlling the abnormality detection method for each operational state of the manufacturing apparatus M.

### Second Embodiment

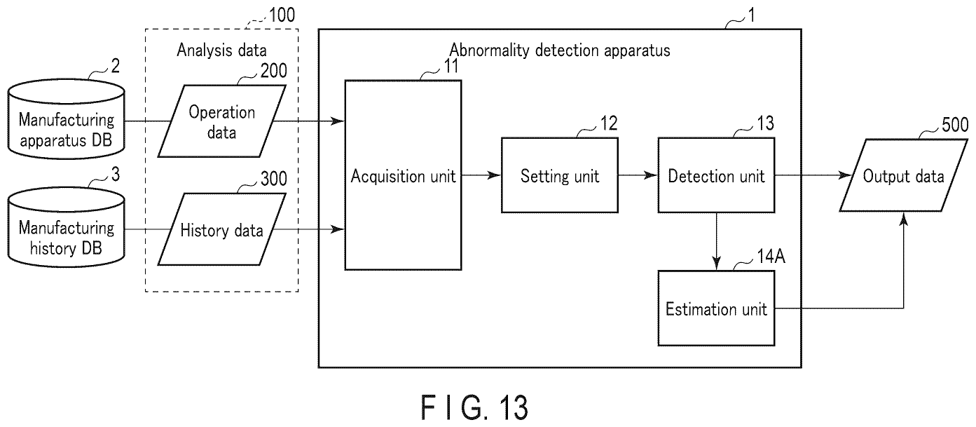

FIG. 13 is a block diagram showing an example of a function configuration of the abnormality detection apparatus 1 according to a second embodiment. The abnormality detection apparatus 1 according to the second embodiment includes an estimation unit 14A in addition to the components of the first embodiment.

The estimation unit 14A estimates various types of data. For example, the estimation unit 14A estimates a cause of the abnormality of the manufacturing apparatus M based on the result of the detection of the abnormality output from the detection unit 13. The estimation unit 14A outputs the output data 500 that includes the result of the estimation of the cause of the abnormality to an external device. That is, the output data 500 includes the result of the detection of the abnormality from the detection unit 13 and the result of the estimation of the cause of the abnormality from the estimation unit 14A.

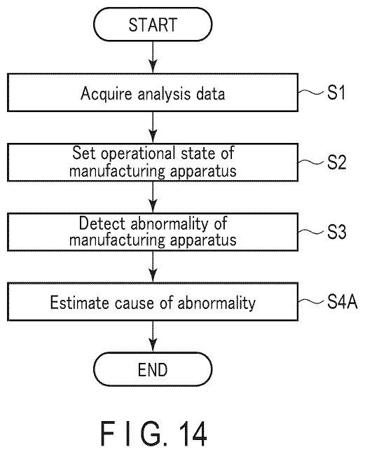

FIG. 14 is a flowchart showing an example of an operation of the abnormality detection apparatus 1 according to the second embodiment. The exemplary operation shown in FIG. 14 includes step S4A in addition to the steps (S1, S2, and S3) of the exemplary operation shown in FIG. 2.

(Step S4A) Lastly, by implementing the estimation unit 14A, the abnormality detection apparatus 1 estimates a cause of the abnormality of the manufacturing apparatus M. Specifically, the estimation unit 14A estimates a cause of the abnormality of the manufacturing apparatus M based on the result of the detection of the abnormality of the manufacturing apparatus M detected in step S3. The estimation unit 14A outputs the output data 500 that includes the result of the estimation of the cause of the abnormality to an external device.

Firstly, the estimation unit 14A may prepare a list of multiple candidates for the cause of the abnormality for the operation data 200 of the manufacturing apparatus M. The list may be prepared for each manufacturing apparatus M or each product, or be prepared for each aspect of the abnormality detection result (i.e., the level of the degree of abnormality, the abnormal mode). The estimation unit 14A may output at least one cause of abnormality corresponding to the operation data 200 that is a processing target among the multiple causes of abnormality included in the list.

Secondly, the estimation unit 14A may estimate a cause of the abnormality of the manufacturing apparatus M by associating the operation data 200 of the manufacturing apparatus M with the history data 300. The history data 300 includes the model number of a product processed by the manufacturing apparatus M, working conditions, etc. The estimation unit 14A may estimate the model number of a product, working conditions, etc., corresponding to the operation data 200 that is a processing target as the causes of the abnormality.

Thirdly, the estimation unit 14A may estimate other operation data 200 correlated with the operation data 200 that is a processing target as the cause of the abnormality. For example, it is assumed that the operation data 200 that is a processing target shows the “pressure” of the manufacturing apparatus M and that the other operation data 200 shows the “temperature” of the manufacturing apparatus M. If the variation in the pressure is correlated with the variation in the temperature, the estimation unit 14A estimates that the cause of the abnormality of the pressure of the manufacturing apparatus M is the temperature of the manufacturing apparatus M.

Fourthly, the estimation unit 14A may estimate the cause of the abnormality of the operation data 200 according to the order or combination of the operational states set in the operation data 200 that is a processing target.

According to the second embodiment described above, the abnormality detection apparatus 1 produces the same effects as those of the first embodiment. Furthermore, the abnormality detection apparatus 1 can contribute to appropriate management of the manufacturing apparatus M by estimating the cause of the abnormality of the manufacturing apparatus M.

### Third Embodiment

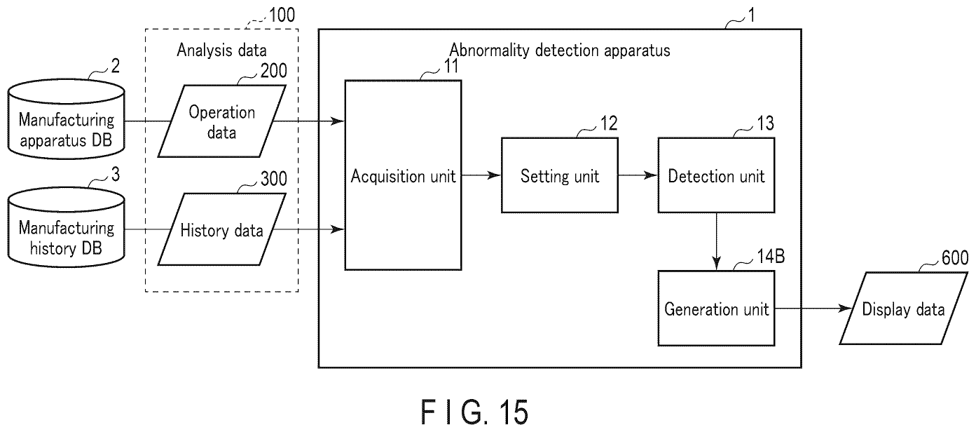

FIG. 15 is a block diagram showing an example of a function configuration of the abnormality detection apparatus 1 according to a third embodiment. The abnormality detection apparatus 1 according to the third embodiment includes a generation unit 14B in addition to the components of the first embodiment.

The generation unit 14B generates various types of data. For example, based on the result of the detection of the abnormality of the manufacturing apparatus M output from the detection unit 13, the generation unit 14B generates display data 600 for displaying the detection result to a display device. The generation unit 14B outputs the generated display data 600 to an external device. The display data 600 may be a text file or an image file in a predetermined format (e.g., CSV, JSON, JPEG).

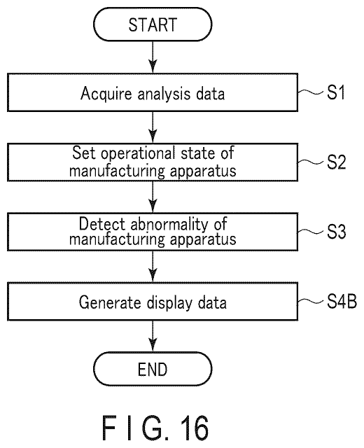

FIG. 16 is a flowchart showing an example of an operation of the abnormality detection apparatus 1 according to the third embodiment. The exemplary operation shown in FIG. 16 includes step S4B in addition to the steps (S1, S2, and S3) of the exemplary operation shown in FIG. 2.

(Step S4B) Lastly, by implementing the generation unit 14B, the abnormality detection apparatus 1 generates the display data 600. Specifically, the generation unit 14B generates the display data 600 based on the result of the detection of the abnormality of the manufacturing apparatus M detected in step S3. The generation unit 14B outputs the display data 600 that includes the abnormality detection result to an external device.

Firstly, the generation unit 14B may express the operation data 200 that is a processing target using a line chart.

Secondly, the generation unit 14B may express the operational state set in the operation data 200 that is a processing target using a character. The generation unit 14B may superimpose the operational state onto the operation data 200 that is a processing target.

Thirdly, the generation unit 14B may express the result of the detection of the abnormality (degree of abnormality) of the manufacturing apparatus M using a character. The generation unit 14B may express the portion of the manufacturing apparatus M having an abnormality using an image, etc., showing an outer appearance of the manufacturing apparatus M.

Needless to say, the display data 600 may include the various types of data described above. Specifically, the display data 600 may include the table 210, 310, 320, 410, 420, 430, 440, 450, or 460. The display data 600 may include the graph 220, 230, 240, 250, 260, 270, 280, 290A, or 290B. The display data 600 may include the time-series data 220A, 221, 222, 223, 224, 225, 250A, 260A, 270A, 280A, 291A, 291B, or 292.

According to the third embodiment described above, the abnormality detection apparatus 1 produces the same effects as those of the first embodiment. Furthermore, the abnormality detection apparatus 1 can contribute to appropriate management of the manufacturing apparatus M by generating the display data 600 that includes the result of the detection of the abnormality of the manufacturing apparatus M.

The abnormality detection apparatus 1 according to another embodiment may include both the estimation unit 14A and the generation unit 14B. In this case, the abnormality detection apparatus 1 may generate the display data 600 that includes the result of the estimation of the cause of the abnormality of the manufacturing apparatus M.

According to another embodiment, the abnormality detection apparatus 1 produces the same effects as those of the second and third embodiments.

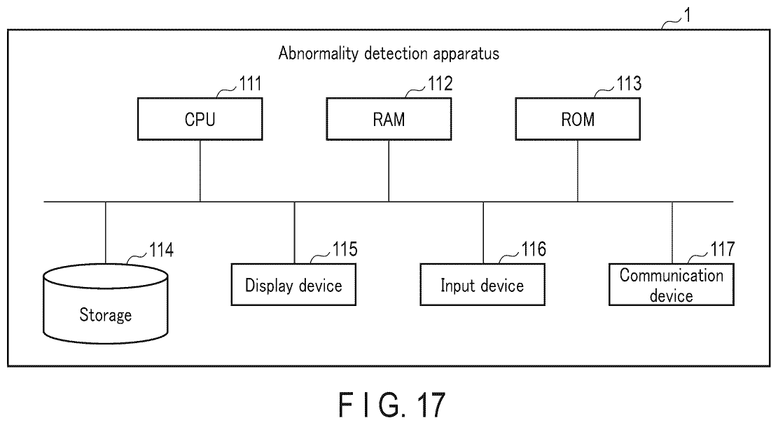

FIG. 17 is a block diagram showing an example of a hardware configuration of the abnormality detection apparatus 1 according to each embodiment. The abnormality detection apparatus 1 includes a CPU 111, a RAM 112, a ROM 113, a storage 114, a display device 115, an input device 116, and a communication device 117 as its components. These components are communicably connected to one another via a bus (BUS), which is a common signal communication path.

The CPU 111 is a processor that executes various kinds of processing according to a program(s). The CPU 111 uses a predetermined area in the RAM 112 as a work area. The CPU 111 realizes each unit (the acquisition unit 11, the setting unit 12, the detection unit 13, the estimation unit 14A, and the generation unit 14B) of the abnormality detection apparatus 1 by reading and executing the program(s) stored in the ROM 113 or the storage 114. The CPU 111 is an example of a processor.

The RAM 112 is a memory for storing various types of data so as to permit rewriting. For example, the RAM 112 is a synchronous dynamic random access memory (SDRAM). The RAM 112 is an example of a storage.

The ROM 113 is a memory for storing various types of data so as not to permit rewriting. The ROM 113 is an example of a storage.

The storage 114 is various kinds of storage media (e.g., a magnetic storage medium, a semiconductor storage medium, an optical storage medium). Alternatively, the storage 114 may be a drive unit that writes or reads various types of data to and from a storage medium under the control of the CPU 111. The storage 114 is an example of a storage unit.

The display device 115 is a device for displaying various types of data. For example, the display device 115 is a liquid crystal display (LCD). The display device 115 displays various types of data under the control of the CPU 111. In particular, the display device 115 may display a display image based on the display data 600. The display device 115 is an example of a display unit.

The input device 116 is a device for receiving input of various types of data. For example, the input device 116 is a mouse or a keyboard. The input device 116 receives operation input from a user as an electric signal, and transfers the electric signal to the CPU 111. In particular, the input device 116 may receive input of an analytical parameter from a user. The input device 116 is an example of an input unit.

The communication device 117 is a device that communicates various types of data with external devices. The communication device 117 communicates with external devices via a network under the control of the CPU 111. In particular, the communication device 117 may receive an analytical parameter from a different system. The communication device 117 is an example of a communication unit.

The various kinds of processing performed by the abnormality detection apparatus 1 may be performed by a general-purpose computer (e.g., a personal computer, a microcomputer, a computing device). For example, a general-purpose computer stores the programs corresponding to the various kinds of processing in a storage medium, and reads and executes the stored programs. Alternatively, a general-purpose computer reads and executes a program(s) from an external storage medium connected thereto by a network (e.g., a LAN, the Internet). Thus, a general-purpose computer can perform processing similar to the processing performed by the abnormality detection apparatus 1.

The storage medium may be a magnetic disk (e.g., a flexible disk, a hard disk), an optical disk (e.g., CD-ROM, CD-R, CD-RW, DVD-ROM, DVD+R, DVD+RW, Blu-ray (registered trademark) disk), a semiconductor memory, or a storage medium similar to them. The storage medium may download and store a program from a network. Needless to say, multiple programs may be respectively stored in multiple storage media.

Instead of a single computer, an actor such as a system composed of multiple computers, an operating system (OS), database management software, or middleware (MW) may perform processing similar to the processing performed by the abnormality detection apparatus 1.

Each unit (the acquisition unit 11, the setting unit 12, the detection unit 13, the estimation unit 14A, and the generation unit 14B) of the abnormality detection apparatus 1 may be on the cloud or on premises.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An abnormality detection apparatus comprising a processor configured to:
acquire analysis data, the analysis data including at least operation data among the operation data and history data, the operation data being data of a manufacturing apparatus configured to intermittently process at least one product, the history data relating to a manufacturing history of the product processed by the manufacturing apparatus;
set an operational state of the manufacturing apparatus in the operation data based on the acquired analysis data; and
detect abnormality of the manufacturing apparatus based on the operation data and the set operational state.

2. The abnormality detection apparatus according to claim 1, wherein the processor changes a method of detecting abnormality of the manufacturing apparatus according to the operational state.

3. The abnormality detection apparatus according to claim 1, wherein the processor sets a first state as the operational state for each time point at which a value of the operation data is equal to or above a threshold and sets a second state as the operational state for each time point at which a value of the operation data is less than the threshold, the second state differing from the first state.

4. The abnormality detection apparatus according to claim 1, wherein
the history data includes a starting time and an ending time of processing performed on the product, and
the processor sets a processing state as the operational state for each time point of the operation data between the starting time and the ending time and sets a non-processing state as the operational state for each time point of the operation data not between the starting time and the ending time.

5. The abnormality detection apparatus according to claim 4, wherein
the history data includes a work content of the processing performed on the product, and
the processor sets a predetermined state corresponding to the work content as the operational state for each time point of the operation data between the starting time and the ending time.

6. The abnormality detection apparatus according to claim 1, wherein the processor detects the abnormality of the manufacturing apparatus based on an order or a combination of the operational states set in the operation data.

7. The abnormality detection apparatus according to claim 6, wherein the processor
sets a non-processing state in a first period of the operation data and sets a processing state in a second period following the first period, and
increases a detection sensitivity to the abnormality of the manufacturing apparatus in the second period to be higher than a detection sensitivity to the abnormality of the manufacturing apparatus in the first period.

8. The abnormality detection apparatus according to claim 1, wherein the processor
transforms the operation data and the set operational state based on an amount of processing on the product, and
detects the abnormality of the manufacturing apparatus based on the transformed operation data and the transformed operational state.

9. The abnormality detection apparatus according to claim 8, wherein the processor
sets a processing state for a predetermined period of the operation data as the operational state, and
detects the abnormality of the manufacturing apparatus based on a comparison between the processing amount in the processing state and a length of the predetermined period.

10. The abnormality detection apparatus according to claim 9, wherein the processor
normalizes the length of the predetermined period based on the processing amount, and
detects the abnormality of the manufacturing apparatus based on a comparison between the processing amount and the normalized length of the predetermined period.

11. An abnormality detection method comprising:
acquiring analysis data, the analysis data including at least operation data among the operation data and history data, the operation data being data of a manufacturing apparatus configured to intermittently process at least one product, the history data relating to a manufacturing history of the product processed by the manufacturing apparatus;
setting an operational state of the manufacturing apparatus in the operation data based on the acquired analysis data; and
detecting abnormality of the manufacturing apparatus based on the operation data and the set operational state.

12. A non-transitory computer readable medium including computer executable instructions, wherein the instructions, when executed by a processor, cause the processor to perform a method comprising:
acquiring analysis data, the analysis data including at least operation data among the operation data and history data, the operation data being data of a manufacturing apparatus configured to intermittently process at least one product, the history data relating to a manufacturing history of the product processed by the manufacturing apparatus;
setting an operational state of the manufacturing apparatus in the operation data based on the acquired analysis data; and
detecting abnormality of the manufacturing apparatus based on the operation data and the set operational state.
